(19) United States
(12) Patent Application Publication
(10) Pub. No.: US 2007/0052675 A1
(43) Pub. Date: Mar. 8, 2007

(54) REMOTE CONTROLLER AND DIGITAL INFORMATION CONTROL SYSTEM EMPLOYING THE SAME

(75) Inventor: TAO-HONG CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,539

(22) Filed: Dec. 31, 2005

(30) Foreign Application Priority Data
Sep. 2, 2005 (CN) 200510037037.2

(51) Int. Cl. G09G 5/08

(52) U.S. Cl. 345/158

(57) ABSTRACT

A remote controller (1000) includes a pointer (1200) for inputting information and a main module (1100). The main module includes a first detection module (1101), a position interpreting module (1102), an information processing module (1106), and a wireless communication module (1107). The first detection module is used for detecting information input by the pointer. The position interpreting module is used for translating the information into position information and control information. The information processing module is used for translating the position information and the control information into cursor location information and remote control codes. The wireless communication module is used for transmitting the cursor location information and the remote control codes.

### FIELD OF THE INVENTION

The invention relates to remote controllers, and particularly to a remote controller and a digital information control system employing the remote controller.

### DESCRIPTION OF RELATED ART

Remote controllers are used to operate electronic devices such as consumer electronic (CE) devices, and a mouse and a keyboard are used to operate most personal computers (PCs). In response to the emerging era of so-called ‘digital living’, the boundary between PCs and CE devices is becoming blurred. For example, some people now watch television (TV) programs on their PC monitor screens. Other people search and retrieve photos in their PCs, and then display the photos on their TV screens.

On screen display (OSD) technology is widely used in image processing devices such as TVs, PCs, and mobile terminals. The OSD can display additional information for a user, such as a channel selection and a display time of the image processing device.

Typically, a remote controller is used to control the OSD of an electronic device. However, a conventional remote controller is considered by many to be unable to provide convenient cursor positioning. In other words, a conventional remote controller is not considered to be user-friendly for OSD control.

### SUMMARY OF INVENTION

An exemplary embodiment of the present invention provides a remote controller. The remote controller includes a pointer and a main module. The pointer is used for inputting information. The main module includes a first detection module, a position interpreting module, an information processing module and a wireless communication module. The first detection module is used for detecting the information inputted by the pointer. The position interpreting module is used for translating the information detected by the first detection module into position information and control information. The information processing module is used for translating the position information and the control information into cursor location information and remote control codes. The wireless communication module is used for transmitting the cursor location information and the remote control codes.

Another exemplary embodiment of the present invention provides a digital information control system for controlling at least one electronic device. The system includes a gateway and a remote controller. The gateway for controlling the electronic device includes an image operating module and a communication module. The image operating module is used for producing a window image with a function list. The communication module is used for communicating with the electronic device. The remote controller for controlling the gateway and the electronic device includes a pointer and a main module. The pointer is used for inputting information. The main module includes a first detection module, a position interpreting module, an information processing module and a wireless communication module. The first detection module is used for detecting the information inputted by the pointer. The position interpreting module is used for translating the information detected by the first detection module into position information and control information. The information processing module is used for translating the position information and the control information into cursor location information and remote control codes. The wireless communication module is used for transmitting the cursor location information and the remote control codes.

Other advantages and novel features will become more apparent from the following detailed description when taken in conjunction with the accompanying drawings, in which:

### BRIEF DESCRIPTION OF DRAWINGS

FIG. 1 is a schematic diagram of a digital information control system of an exemplary embodiment of the present invention;

FIG. 2 is a schematic diagram of a digital information control system of another exemplary embodiment of the present invention;

FIG. 3 is a block diagram of functional modules of a remote controller of the system of FIG. 1 and FIG. 2, the remote controller including a keypad and a pointer;

FIG. 4 is a flowchart of an exemplary method for operating the digital information control system of FIG. 1;

FIG. 5 is a flowchart of an exemplary method for controlling the remote controller by using the keypad of FIG. 3; and

FIG. 6 is a flowchart of an exemplary method for controlling the remote controller by using the pointer of FIG. 3.

### DETAILED DESCRIPTION

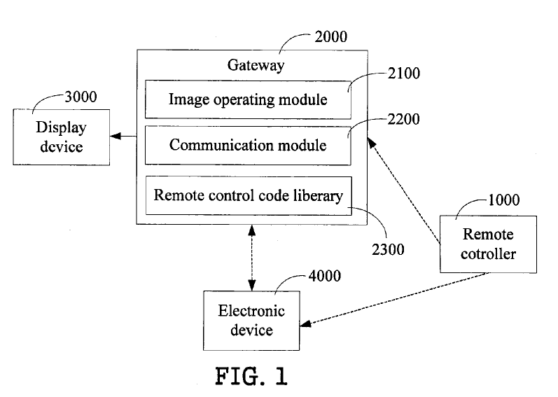

FIG. 1 is a schematic diagram of a digital information control system of an exemplary embodiment of the present invention. In the exemplary embodiment, the system includes a remote controller 1000, a gateway 2000, a display device 3000, and an electronic device 4000. The remote controller 1000 can directly control the gateway 2000, the display device 3000, and the electronic device 4000. The remote controller 1000 can also indirectly control the display device 3000 and the electronic device 4000 via the gateway 2000. In the exemplary embodiment, the electronic device 4000 is assumed to be a DVD (Digital Video Disc) player.

In other exemplary embodiments, the electronic device 4000 may be any of a variety of other kinds of consumer electronic devices, such as a video cassette recorder (VCR), a set top box (STB), a light control device, and so on. In any of these examples, the remote controller 1000 can directly control the electronic device, or indirectly control the electronic device via the gateway 2000.

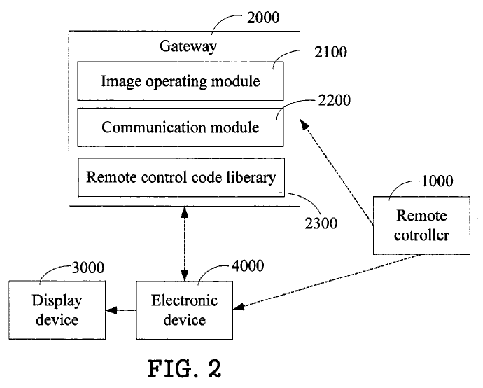

In the exemplary embodiment, the display device 3000 is a television (TV). The remote controller 1000 indirectly controls the electronic device 4000 via the gateway 2000. The display device 3000 is connected to the gateway 2000 by a wired connection. The gateway 2000 can control the display device 3000 to display information of the electronic device 4000. Referring to FIG. 2, in another exemplary embodiment, the display device 3000 may be connected to the electronic device 4000 by a wired connection. In various alternative embodiments, the display device 3000 may be a Liquid Crystal Display (LCD) or another kind of display device.

The gateway 2000 includes an image operating module 2100, a communication module 2200, and a remote control code library 2300. The image operating module 2100 is used for producing a window image with a function list, and the function list can be displayed on the display device 3000. In the exemplary embodiment, the function list is an On Screen Display (OSD) menu. The remote controller 1000 can control the electronic device 4000 via the function list. The communication module 2200 is used for communicating with the remote controller 1000, the display device 3000, and the electronic device 4000. The remote control code library 2300 is used for providing control codes of the electronic device 4000.

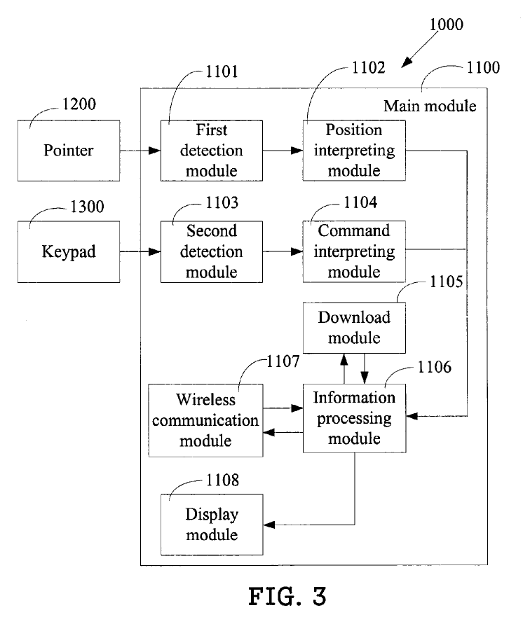

FIG. 3 is a schematic diagram of functional modules of the remote controller 1000. In the exemplary embodiment, the remote controller 1000 includes a main module 1100, a pointer 1200, and a keypad 1300. In an alternative embodiment, the keypad 1300 may instead be another kind of keyboard.

The pointer 1200 is used for inputting information, and for locating a cursor on the function list for selecting a function from the function list. In the exemplary embodiment, the pointer 1200 may be a mouse. In other exemplary embodiments, the pointer 1200 may be a trackball, a joystick, or a touch pad. The pointer 1200 can locate the cursor in a specific place defined by users. In the exemplary embodiment, the specific place is in the center of a screen. The screen is that of the display device 3000. In other exemplary embodiments, the specific place may be a corner, a boundary point, or another place of the screen. Further, the screen may be that of the display module 1108 of the remote controller 1000. The keypad 1300 is connected to the main module 1100, and is used for inputting information to the main module 1100. The input information includes not only channel information but also American Standard Code for Information Interchange (ASCII) information.

The main module 1100 includes a first detection module 1101, a position interpreting module 1102, a second detection module 1103, a command interpreting module 1104, a download module 1105, an information processing module 1106, a wireless communication module 1107, and a display module 1108.

The download module 1105 is used for downloading control codes of the electronic device 4000 via the information processing module 1106 and the wireless communication module 1107. In the exemplary embodiment, the control codes include Infrared Data Association (IrDA) codes saved in the remote control code library 2300 of the gateway 2000. Thus the remote controller 1000 can communicate with the gateway 2000 to download the IRDA control codes via the wireless communication module 1107.

In another exemplary embodiment, the control codes may include markup language codes saved in the electronic device 4000, the electronic device 4000 supporting the Digital Living Network Alliance (DLNA) or the Universal Plug and Play (UPnP) protocol. Thus the remote controller 1000 can use the wireless communication module 1107 to communicate with the electronic device 4000 in order to download the markup language codes by using, for exemplary, the UPnP protocol.

The first detection module 1101 is used for detecting the information inputted by the pointer 1200. The position interpreting module 1102 is used for translating the information detected by the first detection module 1101 into position information and control information. In the exemplary embodiment, the information includes moving information and selecting information of the pointer 1200. The information processing module 1106 is used for translating the position information and the control information into cursor location information and remote control codes. In the exemplary embodiment, the remote control codes correspond to the control codes downloaded by the download module 1105. The wireless communication module 1107 is used for transmitting the cursor location information and the remote control codes to the gateway 2000. In the exemplary embodiment, the wireless communication module 1107 comprises an IrDA interface for transmitting and receiving the remote control codes.

In another exemplary embodiment, the wireless communication module 1107 may comprise an Institute of Electrical and Electronics Engineers (IEEE) 802.11 interface, an IEEE 802.15.4 (Zigbee) interface, an IEEE 802.15.3 (WiMedia) interface, a Bluetooth interface, or a Z-wave interface.

The second detection module 1103 is used for detecting information inputted by the keypad 1300. The command interpreting module 1104 is used for translating the detected information into command information, and sending the command information to the information processing module 1106. The information processing module 1106 is also used for translating the command information into remote control codes. In the exemplary embodiment, the remote control codes correspond to the control codes downloaded by the download module 1105. The wireless communication module 1107 is used for transmitting the remote control codes to the gateway 2000.

The information processing module 1106 is further used for translating the position information, the control information and the command information into display information, which is transmitted to the display module 1108. The display information corresponds to the moving information and the selecting information of the pointer 1200, and the input information of the keypad 1300. The display module 1108 can be used for displaying the display information, the function list of the gateway 2000, and an electronic device list of the digital information control system, and for determining whether the electronic device 4000 is included in the electronic device list. In the exemplary embodiment, the electronic device list includes a list of a plurality of electronic devices of the digital information control system, and is saved in the display module 1108.

In another embodiment, the electronic device list may be empty, or there may be no electronic device list at all. In such cases, the remote controller 1000 can detect electronic devices via the gateway 2000, in order to fill in the electronic device list or compile the electronic device list.

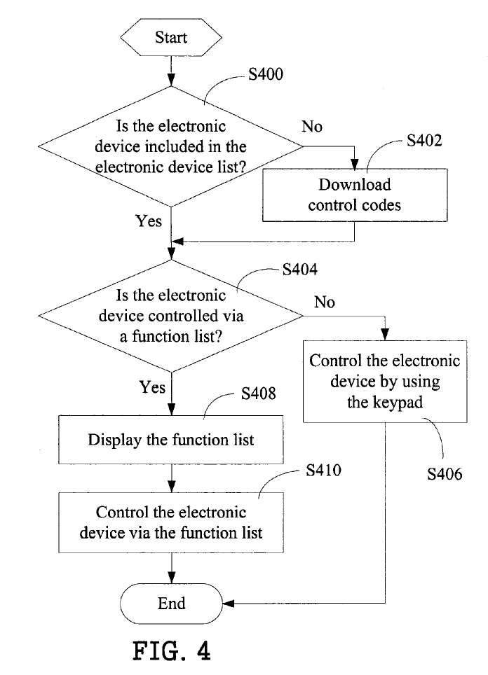

FIG. 4 is a flowchart of an exemplary method for operating the digital information control information system. In the exemplary embodiment, the remote controller 1000 indirectly controls the electronic device 4000 via the gateway 2000.

In step S400, the display module 1108 determines whether the electronic device 4000 is included in the electronic device list of the digital information control system. In the exemplary embodiment, the electronic device list is saved in the display module 1108. The display module 1108 displays the electronic device list, and determines whether the electronic device 4000 is included in the electronic device list.

If the electronic device 4000 is not included in the electronic device list, the remote controller 1000 does not support the electronic device 4000. In such case, in step S402, the downloading module 1105 downloads control codes of the electronic device 4000 via the information processing module 1106 and the wireless communication module 1107. Thereupon the procedure goes to step S404 described below.

If the electronic device 4000 is included in the electronic device list, the remote controller 1000 supports the electronic device 4000, and the procedure goes directly to step S404 described below.

In step S404, a user determines whether the electronic device 4000 is controlled via a function list of the gateway 2000.

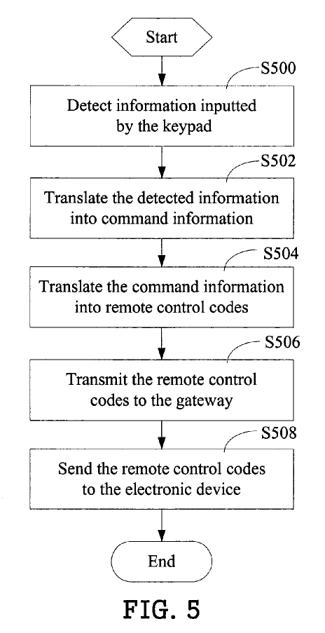

If the electronic device 4000 is not controlled via the function list, in step S406, the remote controller 1000 controls the electronic device 4000 by using the keypad 1300. A detailed description of how the remote controller 1000 controls the electronic device 4000 via the keypad 1300 is provided below in relation to FIG. 5.

If the electronic device 4000 is controlled via the function list, in step S408, the display device 3000 displays the function list. In the exemplary embodiment, the remote controller 1000 controls the image operating module 2100 of the gateway 2000 to produce a window image with the function list via the gateway 2000, and then the function list is displayed on the display device 3000. In another exemplary embodiment, the function list may be displayed on the display module 1108 of the remote controller 1000. The gateway 2000 acquires information about the electronic device 4000 on the function list. In the exemplary embodiment, such information includes playing, stopping, fast forwarding, rewinding, turning off, and so on.

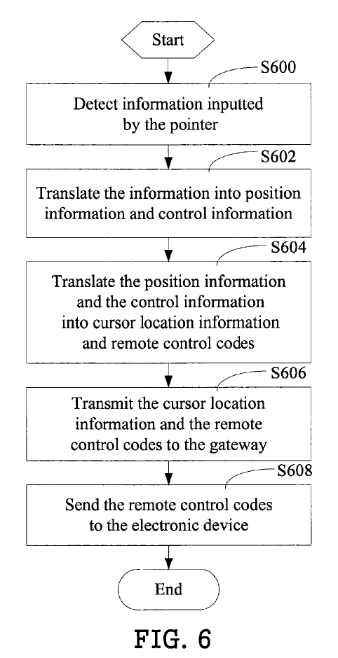

In step S410, the remote controller 1000 controls the electronic device 4000 via the function list. In the exemplary embodiment, the pointer 1200 of the remote controller 1000 is a mouse. Thus the remote controller 1000 can locate a cursor to select a function from the function list via the pointer 1200, in order to control the electronic device 4000. A detailed descriptions of how the remote controller 1000 controls the electronic device 4000 via the pointer 1200 and the function list of the gateway 2000 are provided below in relation to FIG. 6.

FIG. 5 is a flowchart of an exemplary method for controlling the remote controller 1000 by using the keypad 1300. In the exemplary embodiment, the remote controller 1000 controls the electronic device 4000 via the keypad 1300. In step S500, the second detection module 1103 detects information inputted by the keypad 1300, and sends the information to the command interpreting module 1104. In step S502, the command interpreting module 1104 translates the detected information into command information, and sends the command information to the information processing module 1106. In step S504, the information processing module 1106 translates the command information into remote control codes, and sends the remote control codes to the wireless communication module 1107. In step S506, the wireless communication module 1107 transmits the remote control codes to the communication module 2200 of the gateway 2000. In step S508, the gateway 2000 sends the remote control codes to the electronic device 4000 via the communication module 2200, in order to control the electronic device 4000. In the exemplary embodiment, the wireless communication module 1107 and the communication module 2200 each include an IrDA interface. In other exemplary embodiments, the wireless communication module 1107 and the communication module 2200 may each include an IEEE 802.11 interface, an IEEE 802.15.4 interface, an IEEE 802.15.3, a Bluetooth interface, or a Z-wave interface. Finally, the gateway 2000 controls the display device 3000 to display the information inputted by the keypad 1300.

FIG. 6 is a flowchart of an exemplary method for controlling the remote controller 1000 by using the pointer 1200. In the exemplary embodiment, the remote controller 1000 controls the electronic device 4000 via the pointer 1200. In step S600, the first detection module 1101 detects information inputted by the pointer 1200, and sends the information to the position interpreting module 1102. In the exemplary embodiment, the input information includes moving information and selecting information from the function list of the pointer 1200. In step S602, the position interpreting module 1102 translates the information detected by the first detection module 1101 into position information and control information, and sends the position information and the control information to the information processing module 1106. In step S604, the information processing module 1106 translates the position information and the control information into cursor location information and remote control codes, and sends the cursor location information and the remote control codes to the wireless communication module 1107. In the exemplary embodiment, the cursor location information corresponds to the moving information of the pointer 1200, and the remote control codes correspond to the selecting information of the pointer 1200. In step S606, the wireless communication module 1107 transmits the cursor location information and the remote control codes to the communication module 2200 of the gateway 2000. In step S608, the gateway 2000 sends the remote control codes to the electronic device 4000 via the communication module 2200, in order to control the electronic device 4000. In the exemplary embodiment, the wireless communication module 1107 and the communication module 2200 each include an IrDA interface. In other exemplary embodiments, the wireless communication module 1107 and the communication module 2200 may each include an IEEE 802.11 interface, an IEEE 802.15.4 interface, an IEEE 802.15.3, a Bluetooth interface, or a Z-wave interface. Finally, the gateway 2000 sends the cursor location information to the display device 3000, and controls the display device 3000 to display the information inputted by the pointer 1200.

While embodiments and methods have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A remote controller, comprising:
a pointer for inputting information; and
a main module comprising:
a first detection module for detecting the information inputted by the pointer;
a position interpreting module for translating the information detected by the first detection module into position information and control information;
an information processing module for translating the position information and the control information into cursor location information and remote control codes; and
a wireless communication module for transmitting the cursor location information and the remote control codes.

2. The remote controller as claimed in claim 1, wherein the pointer is selected from the group consisting of a mouse, a track-ball, a joystick, and a touch pad.

3. The remote controller as claimed in claim 1, further comprising a keypad or another kind of keyboard, connected to the main module, for inputting information to the main module.

4. The remote controller as claimed in claim 3, wherein the main module further comprises a second detection module for detecting the information inputted by the keypad; and a command interpreting module for translating the detected information into command information and sending the command information to the information processing module.

5. The remote controller as claimed in claim 1, wherein the main module further comprises a download module for downloading control codes.

6. The remote controller as claimed in claim 5, wherein the control codes comprise Infrared Data Association (IrDA) codes and/or markup language codes.

7. The remote controller as claimed in claim 1, further comprising a display module for displaying the input information.

8. The remote controller as claimed in claim 1, wherein the wireless communication module comprises an Infrared Data Association (IrDA) interface.

9. The remote controller as claimed in claim 1, wherein the wireless communication module comprises an interface selected from the group consisting of an IEEE 802.11 interface, an IEEE 802.11 interface, an IEEE 802.15.4 interface, an IEEE 802.15.3, a Bluetooth interface, and a Z-wave interface.

10. A digital information control system for controlling at least one electronic device, comprising:
a gateway for controlling the electronic device, comprising:
an image operating module for producing a window image with a function list; and
a communication module for communicating with the electronic device; and
a remote controller for controlling the gateway and the electronic device, comprising:
a pointer for inputting information; and
a main module comprising:
a first detection module for detecting the information inputted by the pointer;
a position interpreting module for translating the information detected by the first detection module into position information and control information;
an information processing module for translating the position information and the control information into cursor location information and remote control codes; and
a wireless communication module for transmitting the cursor location information and the remote control codes.

11. The control system as claimed in claim 10, further comprising a display device, connected to the gateway, for displaying a electronic device list of the digital information control system, displaying the window image with the function list, and showing a cursor for selecting a function from the function list.

12. The control system as claimed in claim 10, further comprising a display device, connected to the electronic device, for displaying a electronic device list of the digital information control system, displaying the window image with the function list, and showing a cursor for selecting a function from the function list.

13. The control system as claimed in claim 10, wherein the gateway comprises a remote control code library for providing control codes of the electronic device.

14. The control system as claimed in claim 10, wherein the wireless communication module and the communication module each comprise an infrared ray interface.

15. The control system as claimed in claim 10, wherein the wireless communication module and the communication module each comprise an interface selected from the group consisting of an IEEE 802.11 interface, an IEEE 802.11 interface, an IEEE 802.15.4 interface, an IEEE 802.15.3, a Bluetooth interface and a Z-wave interface.

16. The control system as claimed in claim 10, wherein the pointer is selected from the group consisting of a mouse, a track-ball, a joystick and a touch pad.

17. The control system as claimed in claim 10, the remote controller further comprises a keypad or another kind of keyboard, connected to the main module, for inputting information to the main module.

18. The control system as claimed in claim 17, wherein the main module further comprises a second detection module for detecting information inputted by the keypad; and a command interpreting module for translating the detected information into command information and sending the command information to the information processing module.

19. The control system as claimed in claim 10, wherein the main module further comprises a download module for downloading control codes.

20. The control system as claimed in claim 19, wherein the control codes comprise Infrared Data Association (IrDA) codes and/or markup language codes.

21. The control system as claimed in claim 10, wherein the remote controller further comprises a display module for displaying input information.
